(19) United States
(12) Patent Application Publication
(10) Pub. No.: US 2003/0055784 A1
(43) Pub. Date: Mar. 20, 2003

(54) Billing system

(76) Inventors: Nozomu Saruhashi, Osaka (JP); Tetsuo Kuzunishi, Osaka (JP)

Correspondence Address: FROMMER LAWRENCE & HAUG LLP, 745 Fifth Avenue, New York, NY, 10151, US

(21) Appl. No.: 10/215,345

(22) Filed: Aug. 8, 2002

(30) Foreign Application Priority Data
Aug. 10, 2001 (JP) 2001-244173

(51) Int. Cl. G06F 17/60

(52) U.S. Cl. 705/40

(57) ABSTRACT

A system which enables the user to easily utilize services offered by a content provider and to simply and safely pay the service fees is provided.

User-side device (1), content provider-side device (2) and settlement server (3) are connected with each other via communication line and the user-side device comprises a videophone (11), a billing machine (12) and a terminal booth equipped with the videophone and the billing machine, said content provider-side device (2) comprises a videophone (21) which is bi-directionally connected with the videophone (11) of user-side device and PC (23) which carries out a step for displaying the location of user-side device (1) and a step for transmitting the transaction information inputted to the settlement server (3), and a step for displaying the payment information from the settlement server (3). The user enters a terminal booth (13) of a user-side device (1), utilizes content services offered by content providers, and pays the service fee via billing machine (12) placed in the terminal booth (13).

### BACKGROUND OF THE INVENTION

1. Field of the Invention

The present invention relates to a billing system which, when a user selects and utilizes contents or content services offered by a content provider, enables the user to pay the service fees for the contents or content services.

2. Description of the Prior Art

By using a personal computer (hereinafter, referred to as PC) and a network such as Internet, systems for offering media data such as image and sound data, or systems for purchasing goods such as books, entrance tickets of various events or concerts, travel tickets, etc. have been constructed.

In such conventional systems for offering content services via Internet or the like, service fees are paid by a PC-mediated billing system wherein a user notifies the provider of the service (content provider, CP) of the user's settlement informations such as credit card number or bank account number, and then the content provider charges the service fees to settlement facilities based on the credit card number or the bank account number notified by the user.

In such conventional PC-mediated billing system, the procedures of entering, notifying and certifying credit card number or bank account number are troublesome. Further, personal informations such as credit card number notified to content providers may be erroneously leaked, and thus, some users who are worried about such leakage possibility of personal informations may abandon or avoid the utilization of the content services.

Further, when using the conventional PC-mediated billing system, it is impossible to pay service fees in cash.

In addition to the above problems in the conventional PC-mediated billing method, systems for offering content services via Internet have another problem that the range of users may be narrow, since it is difficult or impossible for persons who don't possess PC or persons who cannot operate PC (e.g., persons who cannot operate a keyboard, etc.) to use systems for offering content services via Internet, etc.

Another problem of the systems for offering content services via Internet lies in that a person can utilize content services in a house or company in which personal computers are equipped, but he cannot utilize content services at outer place in which no personal computer is equipped, such as a station, etc., unless he carries any potable terminal devices such as a mobile computer system.

The present invention is designed to solve the problems as described above. The present invention has an object to provide a billing system which enable persons who cannot operate PC to easily utilize content services offered by content providers as well as which enable users to pay the service fee easily and safely.

### SUMMARY OF THE INVENTION

The present invention is to provide a billing system which, when a user selects and utilizes contents or content services offered by a content provider (CP), enables the user to pay the service fees for the contents or content services, comprising a user-side device, a CP-side device and a settlement server.

According to the present invention, said user-side device comprises a videophone having content-selecting icons on its monitor screen, a billing machine which outputs transaction informations transmitted from the settlement server via communication line to ask the user to pay the service fee and which also transmits the payment informations to the settlement server via communication line, and a terminal booth equipped with a videophone and a billing machine therein and having a space in which the user can enter and operate them.

According to the present invention, said CP-side device comprises a videophone which is bi-directionally connected with a videophone of user-side device and a computer which carries out a step for searching the location of a videophone of user-side device based on sender's telephone number informations and displaying it on a display part when the videophone of CP-side device is connected, a step for transmitting transaction informations inputted via an input part to the settlement server via communication line, and a step for receiving payment informations from the settlement server via the communication line and then displaying them on a display part.

According to the present invention, the user enters a terminal booth of a user-side device, operates a videophone to utilize a content service offered by a content provider, and pays the service fee via a billing machine placed in the terminal booth.

In one particular embodiment of the present invention, the billing machine of the user-side device is provided with a cash-receiving part and a credit card-reading part and the user can choose any one method from cash settlement or credit card settlement.

In another particular embodiment of the present invention, for credit card settlement, the credit is checked by the billing machine of the user-side device when the amount of money to be paid is less than a predetermined amount, and the credit is checked by a third-party credit facilities connected with the billing machine of the user-side device when the amount of money to be paid is more than a predetermined amount.

In another particular embodiment of the present invention, the billing machine of the user-side device can issue a membership card when a content provider offers a membership program and a user wishes to join the membership program. In such case, there is no necessity to deliver a membership card to the user. Further, the user can use the membership card as soon as he joins a membership program.

In another particular embodiment of the present invention, the user-side device comprising a videophone, a billing machine and a terminal booth is placed in an easily accessible place, for example, in a shop or in a ticket gate (for example, platform).

### BRIEF DESCRIPTIONS OF THE DRAWINGS

The figures illustrate the invention by way of example. The invention is not meant to be limited to only those embodiments of shown in the Figures. The same reference in different figures indicates the same element is being used in those figures.

FIG. 1 shows a block diagram illustrating the constitution of one embodiment of the present invention.

FIG. 2 shows a perspective view which schematically illustrates the constitution of user-side device (virtual counter) of the invention.

FIG. 3 illustrates an example of menu screen displayed in the videophone's monitor of user-side device.

FIG. 4 shows a plane view of a remote controller used in the videophone of user-side device

FIG. 5 shows a flow chart of one embodiment of the present invention, illustrating the specific proceeding in each step.

FIG. 6 shows also a flow chart of another embodiment of the present invention.

FIG. 7 shows also a flow chart of another embodiment of the present invention.

FIG. 8 illustrates the flow (transmitting and receiving) of informations in embodiments of the present invention.

The symbols used in Figures have the meanings as follows:

1: user-side device

11: videophone

11a: monitor

IC1˜IC8: icons

11b: camera

11c: microphone

11d: speak

11e: remote controller

12: billing machine

13: terminal booth

12a: display part

12b: printing part

12c: cash-receiving part

12d: card-reading part

12e: card-issuing part

2: CP-side device (IP-side device)

21: videophone

22: CTI

23: PC

24: display part

25: input part

3: settlement server

4: third-party credit facilities

### DETAILED DESCRIPTION OF THE PREFERRED EMBODIMENT

According to the present invention, since a billing machine is placed in a user-side device, a user can pay the service fee without notification or registration of the user's settlement informations such as credit card number to a content provider.

According to the present invention, a user can freely choose any one method from cash settlement or credit card settlement. Therefore, if a user is worried about notifying of his credit card number, he can pay the service fee in cash. Further, even if he chooses credit card settlement, the credit is examined by third-party credit facilities or by the own credit checking function of the billing machine, and thus, personal private informations are never leaked to content providers.

Since the present invention adopts a dialogue type system using videophones, persons who do not possess any PC or who cannot operate PC can easily utilize the contents or the content services.

A user-side device according to the present invention is not established in an individual's house or a company. The user-side device is placed in, for example, platform within a ticket gate. Therefore, with feeling as if the user visits the shops or company of the content provider, the users can utilize contents or content services at a place which the user visits on business or private, or during the user's commuting or attending school.

A videophone is placed in a terminal booth which can block public eyes. Even if the booth is placed in a highly traffic or crowded station, a user can freely choose services which is strongly requested to protect personal privacy (e.g., consulting services about beauty, plastic or cosmetic surgery or health, legal advice, loan, etc.) without being aware of other eyes.

In below, the present invention will be further illustrated by reference to the drawings.

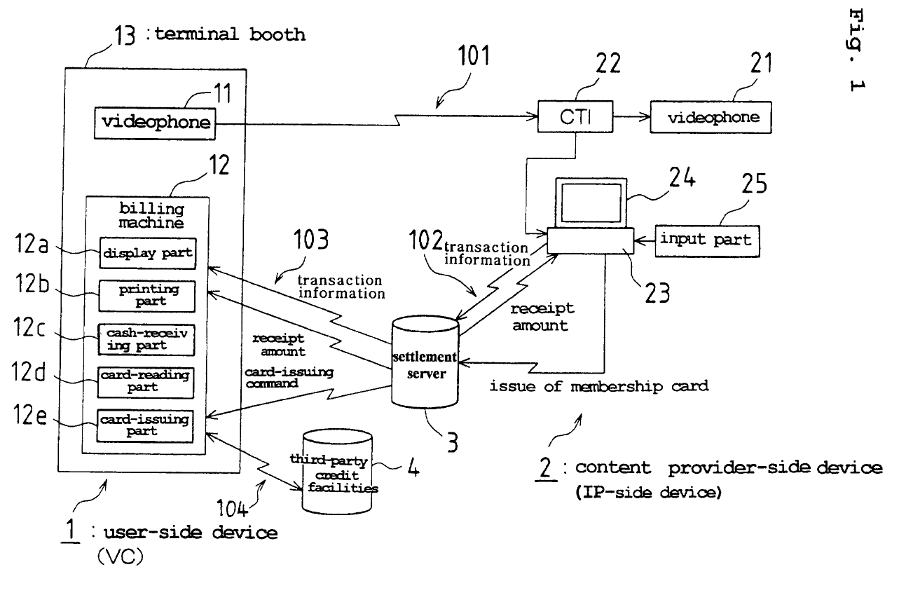

FIG. 1 is a block diagram illustrating the constitution of the billing system of the present invention, which comprises a user-side device (1), a CP-side device (2) and a settlement server (3).

User-side device (1) and CP-side device (2) are bi-directionally connected via telephone line (101). User-side device (1) and settlement server (3) are bi-directionally connected via ISDN (Integrated Services Digital Network) or a telephone line (103). And CP-side device (2) and settlement server (3) are bi-directionally connected via ISDN or telephone line (102).

According to the present invention, user-side device (1) is placed in a railway station or within its ticket gate (for example, platform), or in a shop or any independent facilities. CP-side device (2) is placed in each company of content providers. Settlement server (3) is placed in a company who supervises the system.

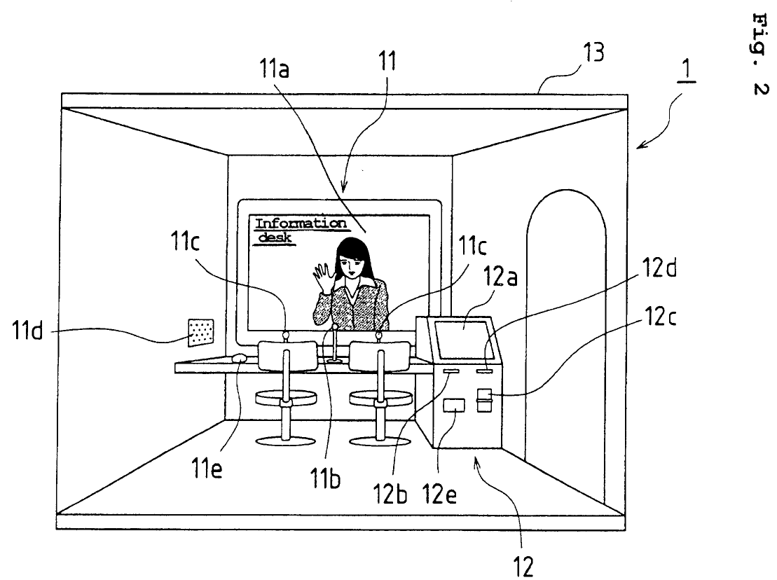

user-side device (1) comprises a videophone (11) and a billing machine (12). These videophone (11) and billing machine (12) are, as shown in FIG. 2, placed in a terminal booth (13) having a space where the user can enter and move.

Videophone (11) comprises a monitor (11a) set on the wall of terminal booth (13), a camera (11b) photographing the user, a microphone (11c), a speaker (11d), a remote controller (11e), etc. The microphone (11c) or speaker (11d) may have a monolithic form or a headset form. as initial screen, the monitor (11a) of videophone (11) displays a menu screen.

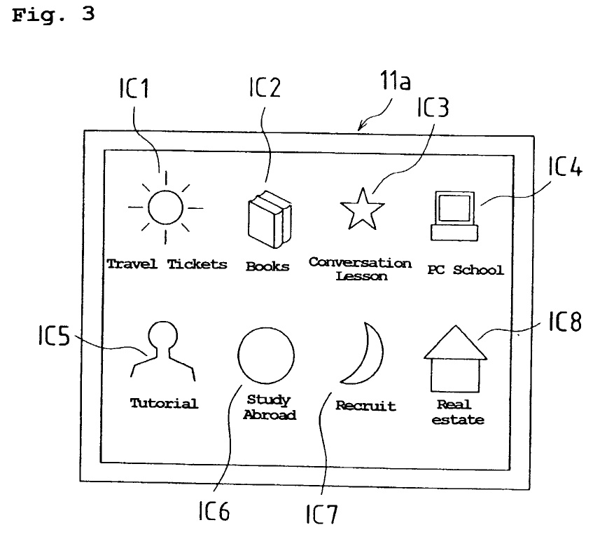

As shown in FIG. 3, icons IC1˜IC8 are arranged in the menu screen. Such icons are intended to select one content from several contents.

In this example, the contents offered by content providers include Travel Ticket (service for buying travel tickets), Book (service for buying books), Conversation Lesson (of six foreign language), PC School, Tutorial, Study Abroad ((service for consulting about Studying abroad), Recruit (service for offering recruit information), Real estate, etc.

The number of icons represented in the monitor screen can be varied without limited to 8 (IC1˜IC8) as shown in FIG. 3. For example, 7 or less icon, or 9 or more icons can be displayed in the screen.

Each icons IC1˜IC8 displayed in the initial screen can be selected by operating a remote controller (11e).

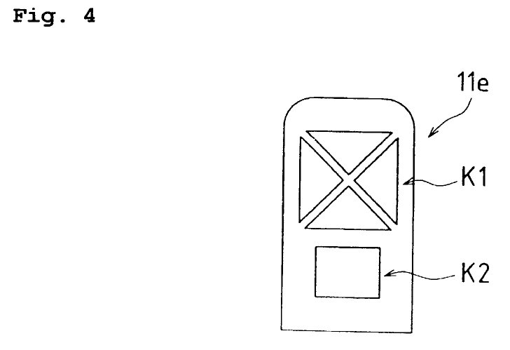

As specific explanation, the remote controller (11e) has cursor keys (K1) for changing the position of the selection indicator, and a determining key (K2) for determining the selected icon, as shown in FIG. 4. A user operates the keys (K1) of the remote controller (11e) to position the selection indicator on an icon (for example, icon IC1 for buying travel tickets) and then operates the determining key (K2) to select the content of the icon.

At the default state of the menu screen, the icons IC1˜IC8 are arranged in the form of a matrix and the selection indicator is positioned on the icon IC1 located in the left top corner of the screen.

The billing machine (12) of the present invention comprises a display part (12a) which displays various informations including transaction and payment informations transmitted via ISDN or telephone line (103) from a settlement server (3), a printing part (12b) which prints receipt, service informations or the like, a cash-receiving part (12c), a card-reading part (12d) which reads credit cards or debit cards, and a card-issuing part (12e) which produces membership cards for a membership clubs.

The cash-receiving part (12c) may have the same structure of automatic cash-receiving machines which are placed in a bank.

When a user wishes to join a membership club, the card-issuing part (12e) issues a membership card for the user according to the instructions of a settlement server (3).

The billing machine (12) as described above is bi-directionally connected with third-party credit facilities (4) via ISDN or a telephone line (104). In addition, the billing machine (12) has the own credit checking function. Therefore, for the credit card settlement, the credit is checked by the own credit checking function of the billing machine (12) when the amount of money to be paid is less than a predetermined amount, for example less than 30,000 yen, and the credit is checked by third-party credit facilities (4) when the amount of money to be paid is more than, for example, 30,000 yen.

The videophone (11) of user-side device (1) adopts the method of selecting and determining an icon by operating a remote controller, but it is possible to adopt a touch panel monitor wherein an icon displayed on a monitor is pressed with a finger to select and determine the contents.

CP-side device (2) comprises a videophone (21) which is bi-directionally connected with a videophone (11) of user-side device (1), CTI (Computer and Telephony Integration) (22) and PC (Personal Computer) (23).

The videophone (21) comprises a camera photographing the user, a monitor for displaying an image, a microphone and a speaker (these are not represented). The videophone (11) of CP-side device has the same structure with those generally employed.

CTI (22) provides PC (23) with the sender's telephone number information of user-side device (1) when the videophone (11) is connected.

PC (23) comprises a display part (24) and an input part (25). The input part (25) is keyboard, mouse or the like, by which the operator can input various informations including transaction informations such as the kind of goods, settlement method, payment amount, etc. Transaction informations may include client informations such as the client's name, address, telephone number.

When a user-side device (1) is connected, PC (23) searches the location of the user-side device (1) based on the sender's telephone number and displays the location informations on the display part (34). PC (23) transmits transaction informations inputted via the input part (25) to settlement server (3) and displays payment informations transmitted from settlement server (3) on the screen of the display part (24).

In addition, when information is inputted that a user wishes to join a membership club planned by a content provider, PC (23) also transmits the user's client informations (name, address, telephone number) to settlement server (3).

Settlement server (3) of the present invention comprises a database (not represented) which contains various informations including client informations (client's name, address, telephone number), transaction informations (kind of goods, settlement method, payment amount, etc), member's informations of clubs, or the like.

Settlement server (3) records transaction informations transmitted from PC (23) of CP-side device (2), and then transmits the transaction informations to the billing machine (12) of user-side device (1). Further, it records payment informations transmitted from the billing machine (12) of user-side device (1), and then transmits the payment informations to PC (23) of CP-side device (2).

In addition, when information about membership card issuance is transmitted from PC (23) of CP-side device (2), settlement server (3) records and registers the client informations (name, address, telephone number) of the applicant (user) into the database, and then transmits a command to issue a membership card to the billing machine (12) of user-side device (1).

In the above embodiments, the videophone (11) and billing machine (12) of user-side device (1) are placed in a terminal booth in which a user can operate. Therefore, other persons cannot know how a user in the terminal booth (13) operates the videophone (11) and what service the user utilizes. Thus, the user can freely choose contents or content services that he is interested in without being aware of other eyes.

In addition, user-side device (1) (hereinafter, referred to as “VC” (Virtual counter)) comprising a videophone (11), a billing machine (12) and a terminal boot (13) is placed in a highly accessible place such as platform.

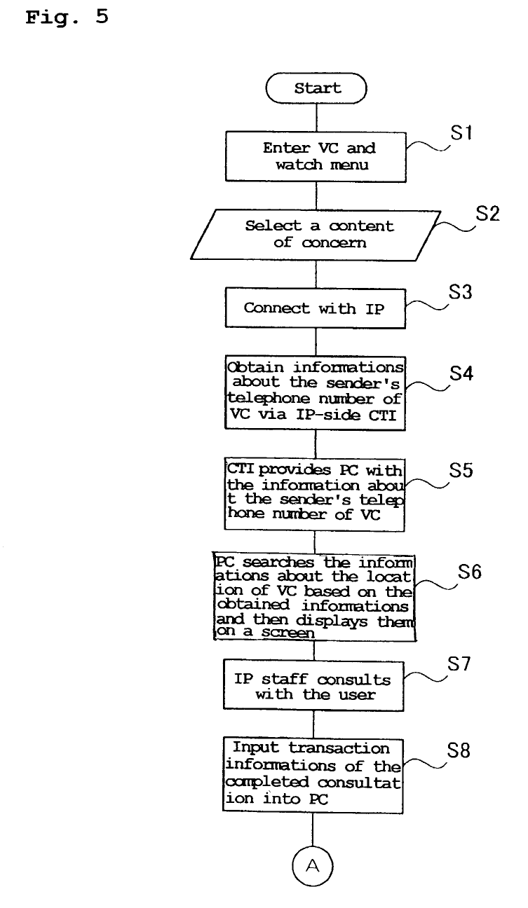

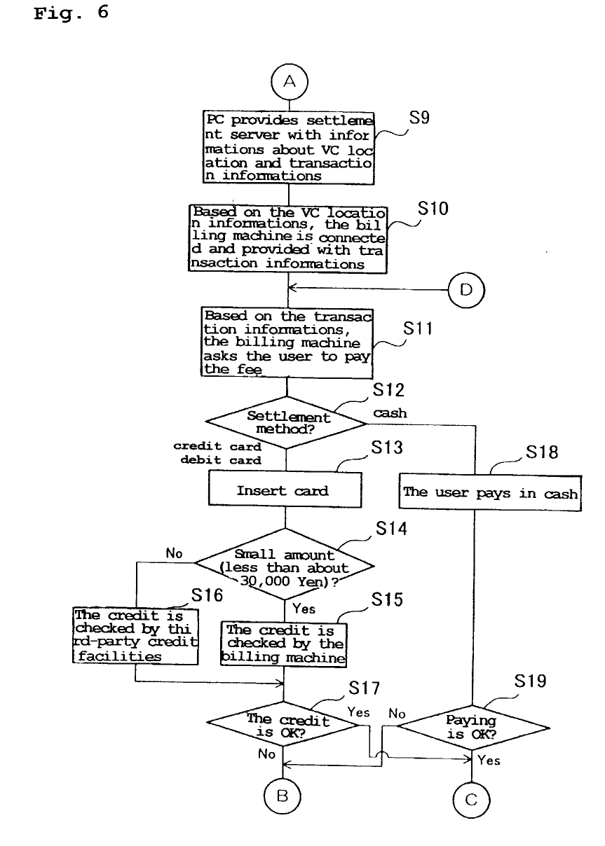

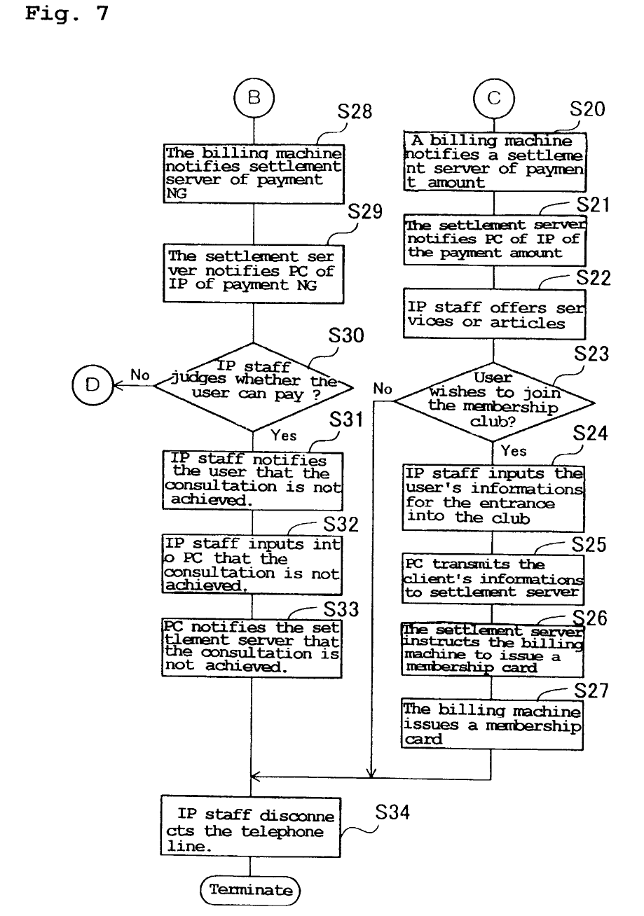

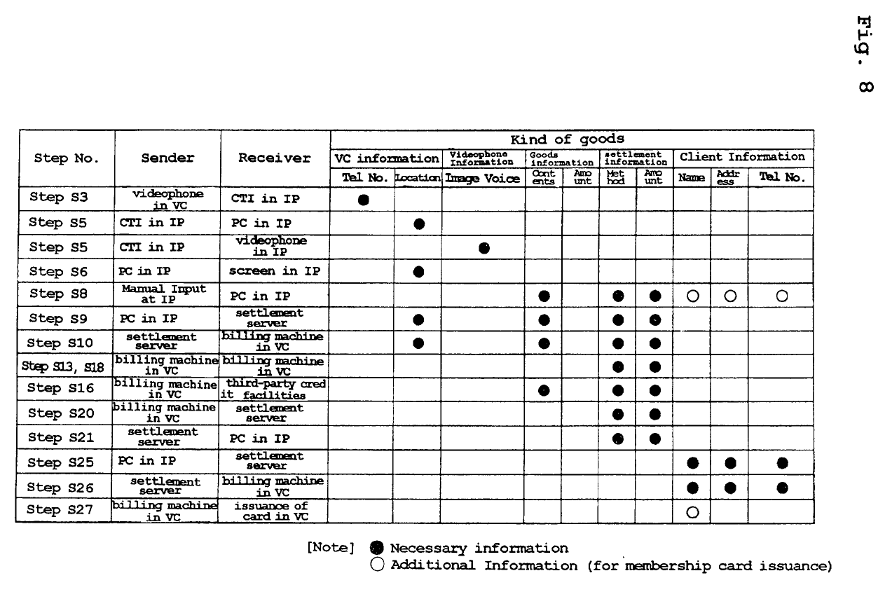

Subsequently, an example of the flow of the present invention is explained by reference to the flow charts of FIGS. 5 to 7 and the transmitting and receiving of informations of FIG. 8.

Further, in the below descriptions concerning these flow charts, content provider and the CP-side device (2) are referred to as IP (Information Provider) and IP-side device, respectively.

Step S1: A user enters VC (terminal booth (13)) and watches the menu screen displayed on a monitor (11a) of a videophone (11)

Step S2: The user selects an icon among IC1˜IC8 displayed in the menu screen (represented as in FIG. 3). In this example, it is assumed that the icon IC1 for buying Travel Ticket is selected.

Step S3: If the icon IC1 displayed in the menu screen is selected (indicated and determined), the IP-side device (a travel agency or company) is accessed.

Step S4: The addresser's telephone number informations of VC are gathered via IP-side CTI(22).

Step S5: are provided to PC (23) by CTI (22) of IP-side device.

Step S6: PC (23) searches the informations about the location of VC based on the obtained informations (the sender's telephone number informations) and then displays them on the monitor of the display part (24).

Step S7: By using the videophone (11) of VC and the videophone (21) of IP-side device which are bi-directionally connected with each other, the user can utilize a consulting service about travel schedule, traffic means, lodging facilities, etc., from a staff (IP staff) of the content provider

Step S8: When the consultation is completed, IP staff inputs into PC (23) transaction informations (e.g., Goods: Travel Ticket, Paying: Cash or Credit card, Paying Amount, etc.). If necessary, the user's informations such as name, address, telephone number, etc. amy be inputted into PC (23).

Step S9: PC (23) provides settlement server (3) with the VC location informations and the transaction informations.

Step S10: Based on the VC location informations from PC (23), the settlement server (3) finds out the specific billing machine (12) among many billing machines placed in many stations, etc. and connects with the billing machine (12) via telephone line (103). The server (3) then offers the transaction informations to the billing machine (12).

Step S11: Based on the transaction information from the settlement server (3), the billing machine (12) outputs any expression to notify the client (user) of the amount of service fee.

Step S12: In the billing machine (12), it proceeds to Step S13 for credit card settlement or it proceeds to Step S18 for cash settlement.

Step S13: For credit card settlement, the user inserts credit card or debit card into the card-reading part (12d) of the billing machine (2).

Step S14: The credit is checked by the own credit checking function of the billing machine when the amount of money to be paid is less than a predetermined amount (e.g., less than 30,000 yen) (Step S15), and the credit is checked by third-party credit facilities (4) when the amount of money to be paid is more than a predetermined amount (for example, 30,000 yen).

Step S17: If the credit examination by the own credit checking function of the billing machine (12) or third-party credit facilities (4) results in “OK”, it proceeds to Step 20, but the credit examination results in “NG”, it proceeds to Step S28.

Meanwhile, for cash settlement, the user pays the corresponding amount of cash into cash-receiving part (12c) of the billing machine (12) (Step S18).

Step S19: The billing machine (12) counts the paid cash into the cash-receiving part (12c) by the user. If the paid cash is the same with the amount to be paid, it proceeds to Step S20, but if different, it proceeds to Step 28.

Step S20: The billing machine (12) informs the settlement server (3) of the settlement information.

Step S21: The settlement server (3) informs PC (23) of the IP-side device of the settlement information.

Step S22: The IP staff provides the user in VC with services or goods. Specifically, by using the videophones (11, 21) connected with each other, the informations about the domestic travel or oversea travel, etc. can be explained to the user via image and/or sound data, or the user can be consulted about studying abroad via image and/or sound data. Likewise, the user can receive the services such as English conversation lesson or tutorial lesson, as well as recruit informations, real estate informations, etc.

Meanwhile, if the goods of the content service is an article such as travel tickets, the IP staff requests a delivery system to deliver the article to the user. For example, the method of delivering articles to users includes the delivery via mail or DHL to the user's house or company, the delivery to the shop or station in which VC is placed at the time appointed by the user, or delivery to the shop or station appointed by the user.

When offering the service or article as described above, if the user has a membership to a club (planned by the IP), the IP staff enters into PC (23) a command to read a card. Said command is transmitted to a billing machine (12) of VC via settlement server (3). When the above command is received, the billing machine (12) asks to the user to insert a membership card into card-reading part (12d). When a membership card is inserted, the data recorded in the membership card are transmitted from the billing machine (12) to PC (23) of the IP-side device via the settlement server (3). As a result, a privilege such as addition of service points or the like is given to the member.

Step S23: After the offering of service/article is completed, IP staff asks whether the user whish to join the membership club. If the user selects to join the club, it proceeds to Step S24. If the user does not want to join the club, the IP staff disconnects the telephone line to terminate the procedure. If the telephone line is disconnected, the screen of the monitor (11) of videophone (11) returns to its initial menu screen (see FIG. 3).

Step S24: By using the videophones (11, 21) connected with each other, IP staff gathers the user's informations (e.g., name, address, telephone number, etc.) from the user and inputs them into PC (23).

Step S25: PC (23) transmits the user's informations and a command to issue a membership card to the settlement server (3).

Step S26: The settlement server (3) instructs the billing machine (12) of VC to issue a membership card.

Step S27: After the billing machine (12) issues a membership card, it proceeds to Step S34 and IP staff disconnects the telephone line to terminate the procedure.

Step S28: Meanwhile, in case where the credit examination results in “NG” at Step S17, or where the paid cash is different from the amount to be paid at Step S19, the billing machine (12) notifies the settlement server (3) of payment “NG”.

Step S29: The settlement server (3) notifies PC (23) of IP-side device of payment “NG” to display it at the display part (24).

Step S30: If IP staff judges that the user can pay the rest, it proceeds to Step S11 to notify the user of the amount to be further paid. If the IP staff judges that the user cannot pay the rest, it proceeds to Step S31.

Step S31: By using the videophones (11, 21) connected with each other, IP staff notifies the user in VC that the consultation is not achieved.

Step S32: IP staff inputs into PC (32) that the consultation is not achieved.

Step S33: After PC (32) notifies the settlement server (3) that the consultation is not achieved, it proceeds to Step S34 and IP staff disconnects the telephone line to terminate the procedure.

According to the present invention, since a user can freely choose any one method from cash settlement or credit card settlement, he can pay the fee in cash when he is worried about notifying of his credit card number.

Further, even if he chooses credit card settlement, the credit card is read by card-reading part (12d) of the billing machine (12) and then examined by third-party credit facilities (4: or the credit checking function programmed in the billing machine). Such system is similar to the system executed in a departments or stores, and thus, personal informations are never leaked to the content providers. Therefore, users can utilize content services without any anxiety.

Since the user can communicate with staffs of the content provider and utilize the content services including Travel Ticket (service for buying travel tickets), Book (service for buying books), Conversation Lesson (of six foreign language), PC School, Tutorial, Study Abroad (service for consulting about studying abroad), Recruit (service for offering recruit information), Real estate, etc., it is possible for persons who could not operate PC and thus could not have utilized various content services to easily utilize the content services.

Since the consultation proceeds in dialogue manner and the services can be utilized after the payment in cash or credit card via billing machine (12), there is no worries that unexpected fee may be charged in someday, which make persons to easily and conveniently utilize the content services according to the present invention.

In addition, since the user-side device is placed in highly convenient places such as platform within a ticket gate, it is possible to utilize services such as English lesson services at stations on the route during his journey. Conventionally, persons who want to get a lesson should exit a station and move to a classroom of a school. In case where VC of the present invention is placed within a station, persons can receive a lesson more effectively since the time for moving form a station to a classroom can be saved.

Further, the examples of content services to which the billing system of the present invention can be applied include guide services such as road guide, medical services such as hospital guide, informations of commercial drugs or the like, consulting services such as legal advice, psychological advice, advice for a mentally and physically disabled persons due to their job, juvenile advice (stay-at-home symptom, school refusal) or the like, services for assisting foreigners in living in Japan, services for assisting handicapped persons in getting jobs, services for offering the user-side device as a interview place between a job offer and a job seeker, and other various services.

What is claims is:

1. The billing system according to the present invention is a billing system which, when a user selects and uses contents or content services offered by a content provider (CP), enables the user to pay the service fees for the contents or content services and comprises a user-side device, a CP-side device and a settlement server, wherein:
said user-side device comprises a videophone having content-selecting icons on its monitor screen, a billing machine which outputs the transaction informations transmitted from the settlement server via communication line to notify the user of the amount of service fee and which also transmits the payment informations to the settlement server via the communication line, and a terminal booth provided with a videophone and a billing machine and having a space in which the user can enter and operate them;
said CP-side device comprises a videophone which is bi-directionally connected with the videophone of user-side device and a computer which, when the videophone of CP-side is on a communication line, carries out a step for searching the location of the videophone of user-side device and displaying it on a display part, a step for transmitting the transaction information inputted via an input part to the settlement server via communication line, and a step for receiving the payment information from the settlement server via the communication line and then displaying it on a display part; and
the user enters a terminal booth of a user-side device, operates a videophone to utilize content services offered by content providers, and pays the service fee via billing machine provided in the terminal booth.

2. The billing system according to claim 1, wherein the billing machine of the user-side device is provided with a cash-receiving part and a credit card-reading part and the user can select any one method from a cash settlement or a credit card settlement.

3. The billing system according to claim 1 or 2, wherein, for the credit card settlement, the credit is checked via the billing machine of the user-side device when the amount of money to be paid is less than a predetermined amount, and the credit is checked by connecting the billing machine of the user-side device with third-party credit facilities when the amount of money to be paid is more than a predetermined amount.

4. The billing system according to any one of claims 1 to 3, wherein the billing machine of the user-side device issues a membership card when a content provider provides a membership program and a user wishes to join the membership program.

5. The billing system according to any one of claims 1 to 4, wherein the user-side device comprising a videophone, a billing machine and a terminal booth is established in a shop or in independent facilities.
